(19) United States
(12) Patent Application Publication
(10) Pub. No.: US 2025/0064654 A1
(43) Pub. Date: Feb. 27, 2025

(54) PARKING DEVICE FOR A SELF-BALANCING WHEELCHAIR

(71) Applicant: GENNY FACTORY SA, Sant'Antonino (CH)

(72) Inventors: Paolo BADANO, Sant'Antonino (CH); Luca WULLSCHLEGER, Sant'Antonino (CH)

(73) Assignee: GENNY FACTORY SA, Sant'Antonino (CH)

(21) Appl. No.: 18/729,593

(22) PCT Filed: Jan. 16, 2023
(86) PCT No.: PCT/EP2023/050814

§ 371 Date: Jul. 17, 2024

(30) Foreign Application Priority Data
Jan. 17, 2022 (IT) 102022000000602

(51) Int. Cl. A61G 5/10

(52) U.S. Cl. CPC A61G 5/1032; A61G 5/1029

(57) ABSTRACT

A parking device for a motorized self-balancing wheelchair, connected to a wheelchair base by a pair of leverages is disclosed. Each of the leverages is connected by a proximal lever, to a shared gear driven by a gearmotor assembly that in turn is keyed, or constrained, to one of the leverages. Each proximal lever is articulated to a distal lever and each distal lever is connected by a guide to the base of the wheelchair and has a supporting foot to be supported on the ground. The shared gear has a pair of cogwheels meshing with one another and each of the cogwheels is integral to a proximal lever of the couple of leverages and has its own rotation axis, so that the operation of the gearmotor assembly puts the pair of cogwheels in simultaneous rotation to drive the leverages up or down.

### FIELD OF INVENTION

Object of the present invention is a parking device for a self-balancing wheelchair, or rather a parking device for a motorized self-balancing wheelchair, for example but not exclusively, for transporting at least one person or otherwise for robotic applications, that is to say without people on board.

### KNOWN PRIOR ART

It is well known that there are motorized self-balancing wheelchairs for people who lack, even partially, lower limb mobility. Specifically, it is known that there is a motorized wheelchair for transporting a person in a sitting position that comprises a user-operable base for activating said motorized wheelchair, two wheels each arranged on either side of said base and supported on a running surface, and a supporting frame that is integrally constrained to said base and equipped with a seat. In particular, this type of motorized wheelchair also comprises means to self-balance its weight under any working condition, which are also used in the people transporting device known as SEGWAY®.

Such self-balancing, or balancing, means to balance the weight of the wheelchair are housed within said base together with also additional means for changing the direction of forward movement of the wheelchair. In this type of wheelchair, the forward and/or backward movement is achieved by the forward/backward unbalancing of the user's body.

In addition, the wheelchair activation is achieved at the time when a person sits on the wheelchair seat and his or her weight is used to detect the presence of the user and activate the electrical operation of the wheelchair. However, this type of wheelchair has the drawback of not being stable when not in operation, that is, when the internal electric motor is no longer operating, the wheelchair being equipped with only two wheels placed parallel and opposite to each other.

Even in cases where the electric motor is operating, when the wheelchair is in a stable resting position, there may still be events where possible and unexpected external forces may cause such wheelchair to lose stability, with potentially very dangerous outcomes.

However, in this regard, the wheelchair is equipped with bearing means (so-called “parking assembly or device”) to bear said wheelchair on the running surface, when in non-operating conditions or otherwise when maintained in a parking position.

WO 2012/017335 A1 illustrates a stabilizing assembly that can be applied to a motorized self-balancing wheelchair for transporting at least one person, which comprises a platform located between a pair of electrically motorized coaxial wheels and carries load detecting means arranged to detect the presence of the driver on the platform and to provide consent for the activation of an electronic steering unit adapted to control the motorized wheels also in response to balance changes. The stabilizing assembly includes leverages that control a pair of supports able to be positioned at the front and rear of said platform, respectively, and able to be selectively moved by the driver on said seat between a lowered position of ground support and an inoperative raised position, and vice versa.

The movements of the leverages of the known stabilizing assembly can be controlled by the user himself by means of a manually operating lever or bar arranged beside and below the wheelchair seat.

Document EP 2 606 867 A1 illustrates a motorized self-balancing wheelchair for transporting at least one person, comprising a base operable for activating said motorized wheelchair, two wheels each arranged on either side of said base and supported on a running surface. The motorized wheelchair has a supporting frame that is integrally constrained to the base and equipped with a seat, and bearing means to bear said wheelchair on the running surface at least when in a non-operating condition. The bearing means comprise at least one foot that can be supported on the ground. There are also means for moving and locking the feet between a raised position and a lowered position, and vice versa. The feet are locked in lowered position at least when in contact with the running surface so that the wheelchair is supported in a substantially horizontal position.

Document FR 3 106 492 describes a wheelchair that comprises a seat mounted on a gyropod, wherein, as known, the term gyropod refers to an individual electric vehicle, consisting of a platform with two parallel wheels (which platform in this case supports the chair), and equipped with a gyroscopic stabilizing system.

Thanks to the gyroscopic stabilizing system of the gyropod, when the user bends forward, the center of gravity of the wheelchair-user assembly moves forward, thus causing a signal to be sent to the motorized wheels for moving the wheelchair in the forward direction along a longitudinal axis. Similarly, when the user bends backward, the center of gravity of the wheelchair-user assembly moves backward, a signal for the motorized wheels is generated to move the wheelchair in a rearward direction along said longitudinal axis.

Specifically, the gyroscopic stabilizing system comprises an electronic board configured to calculate in real time the center of gravity of the wheelchair occupied by the user from data received from a series of sensors. The electronic board further controls the motorized wheels based on the calculated position of the center of gravity. The sensors are, for example, accelerometers or gyroscopes. The sensors and electronic board are housed in an electronic box placed, for example, sideways between the wheels.

This device allows the activation system to be deactivated when the support is in the rest position and the user is seated in order to prevent unwanted movements of the wheelchair, and also provides mechanical connecting means configured to hook the activation system 35 when the legs are in the retracted position and to unhook the activation system when the legs are in the deployed position, while the user is in the seat.

Finally, the chair comprises a pair of shanks where the first portions of each shank have toothed ends that mutually mesh.

However, the problem of making the wheelchair stationary on both flat and steeply sloping terrain is not addressed by this document.

Therefore, object of the present invention is to provide a motorized wheelchair that can be borne in a substantially horizontal position even when left on a running surface that is not perfectly flat, or even sloping or that has unevenness or that is yielding.

Further object of the present invention is to provide a motorized wheelchair that allows the problems of known art to be solved without introducing additional complex electronic control systems, but only through mechanical elements.

### BRIEF DESCRIPTION OF THE INVENTION

These objects are achieved by a parking device for a motorized self-balancing wheelchair, wherein the aforesaid device is connected to a base of the aforesaid self-balancing wheelchair by means of a pair of leverages, wherein each of the aforesaid leverages is connected, by means of a proximal lever, to a shared gear that can be driven by means of a gearmotor assembly that in turn is constrained, and preferably keyed, to one of the aforesaid leverages, each of the aforesaid proximal levers being articulated to a respective distal lever, characterized in that wherein each of the aforesaid distal levers is guided along a respective guide, wherein the aforesaid guide is constrained to the base of the wheelchair and has a respective supporting foot for supporting on the ground, wherein the aforesaid shared gear has a pair of cogwheels meshing with one another, wherein each of the aforesaid cogwheels is integral to a respective proximal lever of the couple of leverages and has its own rotation axis, in such a way that the operation of the gearmotor assembly simultaneously rotates the pair of cogwheels, to drive the aforesaid leverages up or down.

The advantages of this embodiment include the fact that the device of the invention can be used to make the wheelchair stationary on both flat and steeply sloping terrain.

According to an embodiment of the present invention, the aforesaid shared gear is accommodated in a holder having a fulcrum at a rotation axis that is different from the rotation axes of the aforesaid cogwheels.

An advantage of this embodiment is that it gives the possibility of making the wheelchair stationary on steep slopes, thanks to the swinging system of the holder in which the electric motor is hinged.

In particular, the first part of the movement brings the feet down. When either foot touches the ground, the holder swings until the second foot also touches the ground.

This allows the force exerted by a single foot to be minimized, whereas when both are on the ground, a supporting reaction is generated.

According to an embodiment of the invention, the gearmotor assembly comprises a pair of motors both acting on the shared gear.

An advantage of this solution is that if one of the two motors fails, the other still remains to ensure movement and in particular to ensure that the two proximal levers move simultaneously.

According to a further embodiment of the invention, the device further provides a locking system which suppresses the degree of freedom of the system composed of the leverages and the gearmotor when both feet are on the ground, in order to ensure the stability of the parking device.

An advantage of this solution is that the locking system ensures the stability of the parking device which would otherwise be unstable, since, by applying a torque to the base, the latter would tend to rotate thus causing the wheelchair to move forward.

Further characteristics of the invention can be deduced from the dependent claims.

### BRIEF DESCRIPTION OF THE FIGURES

Further characteristics and advantages of the invention will become apparent from the following description given by way of non-limiting example, with the aid of the figures depicted in the attached drawings, in which:

FIG. 1 depicts a side view of a motorized self-balancing wheelchair equipped with a parking device, according to an embodiment of the present invention;

FIG. 2 depicts a side view of the parking device in FIG. 1 in retracted position when the wheelchair is on a flat surface;

FIG. 3 depicts a side view of the parking device in FIG. 1 in extended position in contact with the ground when the wheelchair is on a flat surface;

FIG. 4 depicts a side view of the parking device in FIG. 1 in retracted position when the wheelchair is on a slope having a 10° gradient;

FIG. 5 depicts a side view of the parking device in FIG. 1 in extended position in contact with the ground when the wheelchair is on a slope having a 10° gradient;

FIG. 6 depicts a side view of the parking device in FIG. 1 in retracted position when the wheelchair is on a slope having a 15° gradient;

FIG. 7 depicts a side view of the parking device in FIG. 1 in extended position in contact with the ground when the wheelchair is on a slope having a 15° gradient;

FIG. 8 depicts a side view of the parking device in FIG. 1 in retracted position when the wheelchair is on a slope having a 20° gradient;

FIG. 9 depicts a side view of the parking device in FIG. 1 in extended position in contact with the ground when the wheelchair is on a slope having a 20° gradient;

FIG. 10 depicts a side view of a portion of motorized self-balancing wheelchair equipped with a parking device, according to an alternative embodiment of the present invention;

FIG. 11 depicts a side view of the parking device in FIG. 10 in retracted position;

FIG. 12 depicts a side view of the parking device in FIG. 10 in extended position;

FIG. 13 depicts a side view of the parking device in FIG. 10 in side-extending position;

FIG. 14 depicts a side view of a locking system of the parking device in FIG. 10 in locked position; and

FIG. 15 depicts a side view of a locking system of the parking device in FIG. 10 in unlocked position.

### DETAILED DESCRIPTION OF THE FIGURES

Now, the present invention will be described with special reference to the attached figures.

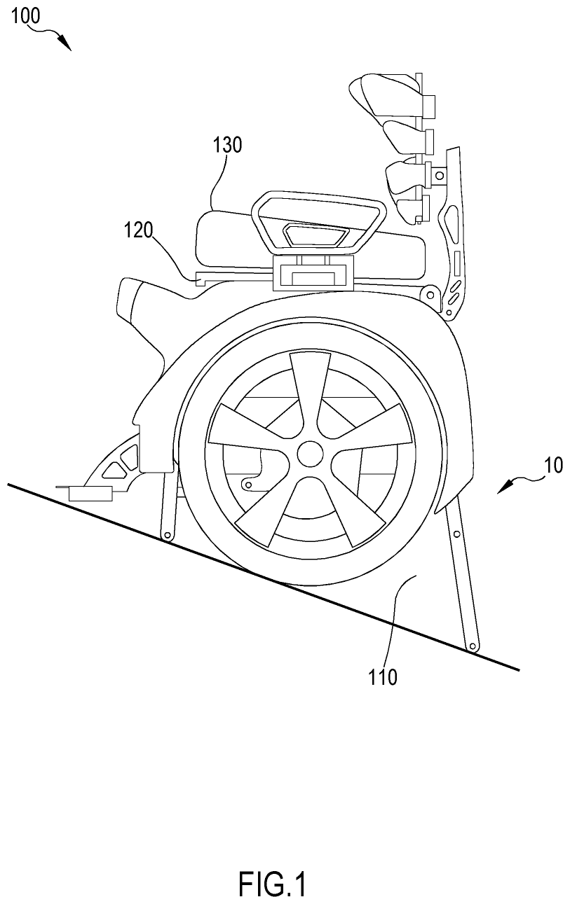

In particular, FIG. 1 depicts a side view of a motorized self-balancing wheelchair globally denoted by the numerical reference 100 and equipped with a parking device, according to an embodiment of the present invention.

It should be specified, for a more exhaustive description of the invention, that the motorized self-balancing wheelchair 100 can be used, for example but not exclusively, by people who lack, even partially, lower limb mobility or for robotic applications.

Such a wheelchair comprises a base 20 operable by the user to activate the wheelchair and two wheels 110 that are each arranged on either side of the base 20 and supported on a running surface, and a supporting frame 120 integrally constrained to the base and equipped with a seat 130.

In particular, this type of motorized wheelchair also comprises means to self-balance its weight under any working condition, of the type for example also used in the device for transporting people known under the name of SEGWAY®.

Such self-balancing, or balancing, means to balance the weight of the wheelchair are housed within said base together with also additional means for changing the direction of forward movement of the wheelchair. In this type of wheelchair, forward and/or backward movements, as well as possibly the (steering) direction, are achieved by unbalancing the user's body forward and/or backward, as well as possibly to the side.

Alternatively, or in addition, a drive handlebar can contribute to determine, or exclusively determine, the forward and/or rearward movements of the vehicle, in addition to the direction of motion (steering) of the same vehicle.

Furthermore, in some preferred embodiments, the activation of the wheelchair is achieved at the time in which a person sits on the wheelchair seat and his or her weight is used to detect the presence of the user and activate the electrical operation of the wheelchair.

Alternatively, the simultaneous detection of the user's weight and the operation of a manual control by the user himself is required for the wheelchair activation.

The self-balancing wheelchair described herein is equipped, according to an aspect of the present invention, with a parking device of the type having supporting feet able to be lowered and lifted. This parking device is preferably manually activated by the operator and only starts working when the wheelchair is stationary.

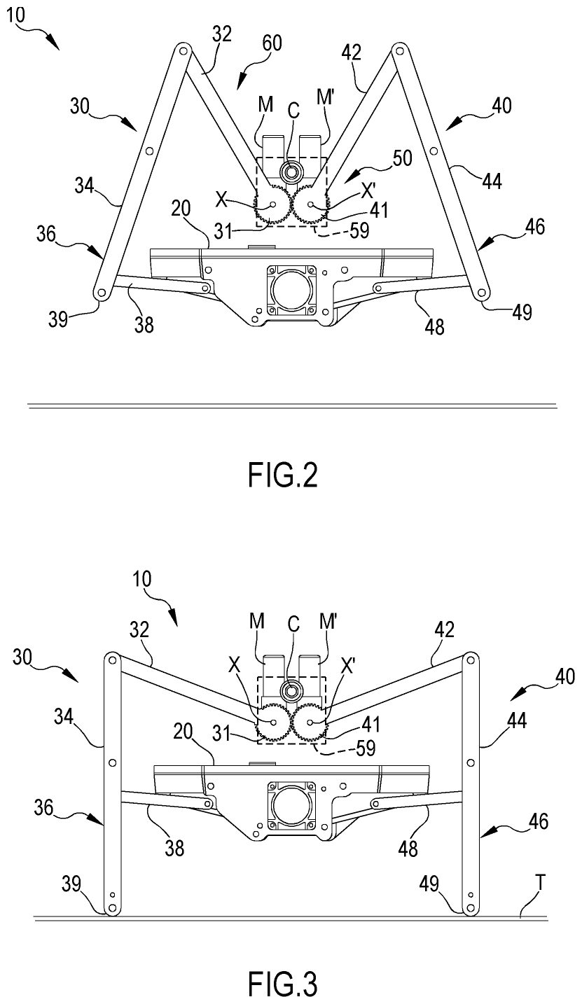

FIG. 2 depicts a side view of the parking device of the invention, globally denoted by the numerical reference 10, in the retracted position when the wheelchair is on a flat surface.

In particular, the parking device 10 of the invention is connected to a base 20 of the self-balancing wheelchair 100 by a pair of front and rear leverages 30, 40.

Each of the aforesaid leverages 30, 40 is connected, by means of a proximal lever 32, 42, to a shared gear 50 that can be driven by means of a gearmotor assembly 60 that in turn is keyed, or in any case constrained, to one of the aforesaid leverages 30, 40.

Specifically, the gearmotor assembly 60 comprises a pair of motors M, M′ which both act on the worm screw 51.

More specifically, the front leverage 30 is connected via the proximal lever 32 to the shared gear 50, while the front leverage 40 is connected via the proximal lever 42 to the shared gear 50.

The gearmotor assembly 60 is preferably keyed to one of the leverages 30, 40, for example to the front leverage 30 or to the rear leverage 40.

The proximal lever 32 of the front leverage 30 is articulated to a distal lever 34 of the front leverage 30, while the proximal lever 42 of the rear leverage 40 is articulated to a distal lever 44 of the rear leverage 40.

Specifically, in the embodiment of the invention depicted herein, the proximal lever 32 of the front leverage 30 is articulated at an end thereof to an end of the respective distal lever 34, and similarly the proximal lever 42 of the front leverage 40 is articulated at an end thereof to an end of the respective distal lever 44.

The distal lever 34 of the front leverage 30 has a supporting foot 39 to be supported on the ground, while the distal lever 44 of the rear leverage 40 has a supporting foot 49 to be supported on the ground, so that the assembly of the front 30 and rear 40 leverages forms a mechanical equivalent of the “shanks” of the motorized wheelchair 100, meaning that a front support and a rear support are provided to the wheelchair 100 itself when it is parked on a flat surface or along a slope.

The supporting feet 39, 49 of the distal levers 34, 44 of the front 30 and rear 40 leverages, respectively, are made at the ends of the distal levers 34, 44 which are not engaged with the respective proximal levers 32, 42.

Each of the distal levers 34, 44 is connected by a respective guide 36, 46 (for example in the form of a sliding block) to a respective connecting lever 38, 48 which in turn is fixed to the base 20 of the wheelchair 100.

Specifically, the distal lever 34 of the front leverage 30 is connected via a front guide 36 to a front connecting lever 38, which in turn is fixed to the base 20 of the wheelchair 100, while the distal lever 44 of the rear leverage 40 is connected via a rear guide 46 to a rear connecting lever 48, which in turn is also fixed to the base 20 of the wheelchair 100.

The front and rear guides 36, 46 allow the respective distal levers 34, 44 to slide and rotate with respect to the respective connecting lever 38, 48 and more specifically with respect to the ends of those connecting levers 38, 48 fixed to the base 20.

Alternatively, other connections of the distal levers 34, 44 to the base 20 of the wheelchair 100 are possible by means of general guides 36, 46—to be understood herein in the general sense of mechanical constraints-which connect these distal levers 34, 44 to the base 20 so that they can preferentially roto-translate with respect to the latter. For example, guides 36, 46 consisting of a sliding block directly hinged to the base 20 and within which the respective distal lever 34, 44 slides, or otherwise other known mechanical constraints that allow the expected relative movement between the levers 34, 44 and the base 20, may be used.

The shared gear 50 has a pair of cogwheels 31, 41, wherein each of said cogwheels 31, 41 is integral with a respective proximal lever 32, 42 of the respective leverage 30, 40.

More specifically, the shared gear 50 has a front gear wheel 31, which is integral with the proximal front lever 32 of the front leverage 30 and has a rotation axis X.

In addition, the shared gear 50 has a rear cogwheel 41 which is integral with the proximal rear lever 42 of the rear leverage 40 and has a rotational axis X′. Moreover, in the shared gear 50, the front cogwheel 31 meshes with the rear cogwheel 41.

Furthermore, the shared gear 50 is accommodated in a holder 59 having a fulcrum at a rotation axis C that is different from the rotation axes X, X′ of the cogwheels 31, 41.

The operation of the parking device 10 for a motorized self-balancing wheelchair 100 takes place as follows.

The operation of the gearmotor assembly 60 simultaneously rotates the pair of cogwheels 31, 41, which in turn drive the aforesaid front and rear leverages 30, 40 up or down.

Specifically, in the case of FIGS. 2 and 3, the parking device 10 switches from a retracted position to an extended position in a situation in which the wheelchair 100 is on a flat surface.

The operation of the gearmotor assembly 60 and the resulting simultaneous rotation of the pair of cogwheels 31, 41 causes both the proximal lever 32 of the front leverage 30 to rotate around its rotation axis X and the proximal lever 42 of the rear leverage 40 to rotate around its rotation axis X′.

The proximal lever 32 acts on the distal lever 34, which is guided by the guide 36 downward until touching the ground, as well as, in the same way, the proximal lever 42 acts on the distal lever 44, which is guided by the guide 46 downward until touching the ground, thus leading the configuration of device 10 to the position depicted in FIG. 3.

The operation of the gearmotor assembly 60 in the opposite direction allows the device 10 to repeat in reverse the same movements described, in order to lead the parking device 10 from an extended position to a retracted position.

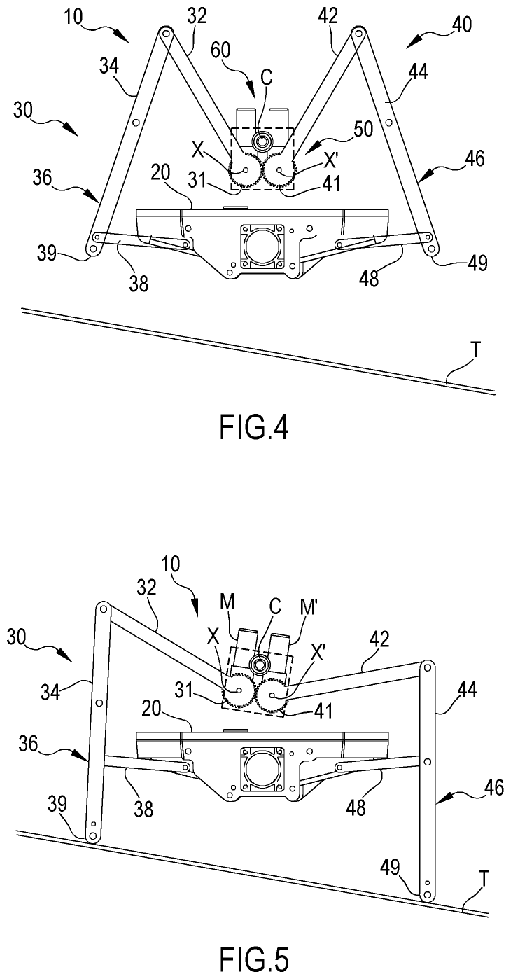

FIG. 4 depicts a side view of the parking device in FIG. 1 in the retracted position when the wheelchair is on a slope having a 10° gradient.

The operation of the gearmotor assembly 60 and the resulting simultaneous rotation of the pair of cogwheels 31, 41 causes both the proximal lever 32 of the front leverage 30 to rotate around its rotation axis X and the proximal lever 42 of the rear leverage 40 to rotate around its rotation axis X′.

The proximal lever 32 acts on the distal lever 34, which is guided by the guide 36 downward until touching the ground, as well as, in the same way, the proximal lever 42 acts on the distal lever 44, which is guided downward by the guide 46.

However, unlike the previous case, as the wheelchair 100 is placed on a slope having a 10% gradient, in this case the distal lever 34 and the respective foot 39 touch the ground T at an earlier time than the contact of the distal lever 44 and its foot 49.

At the moment when the distal lever 34 and the respective foot 39 touch the ground T, the shared gear 50 rotates about its center of rotation C and also allows the distal lever 44 and the respective foot 49 to reach the contact with the ground T, thus leading the parking device to the position shown in FIG. 5, with the base 20 still remaining in a horizontal position.

In this case as well, the operation of the gearmotor assembly 60 in the opposite direction allows the device to repeat in reverse the same movements described, in order to lead the parking device from an extended position to a retracted position, i.e. the position shown in FIG. 4.

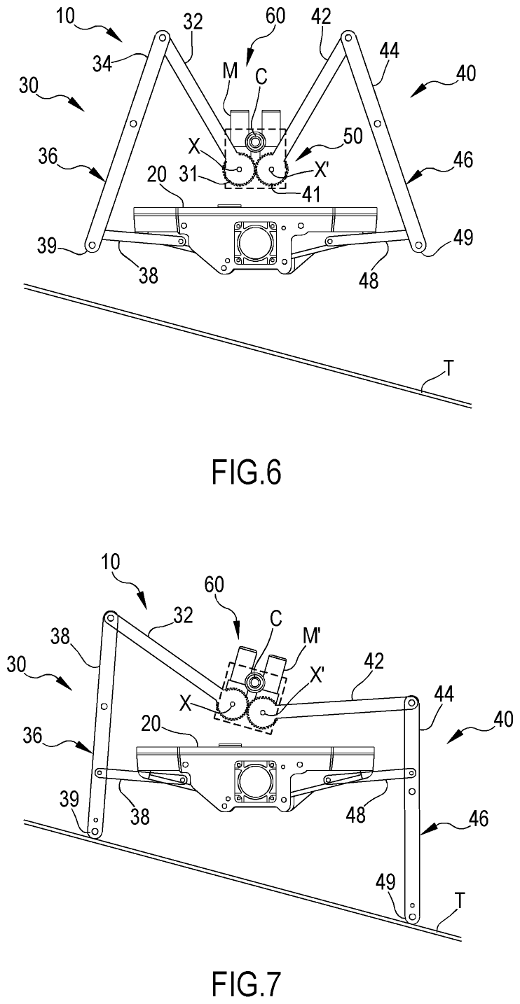

FIGS. 6 and 7 depicts movements similar to those shown in FIGS. 4 and 5 above, the only difference being that in this case the wheelchair 100 is on a slope having a 15° gradient.

In this case, in the final position shown in FIG. 7, the shared gear 50 is more tilted than in the position shown in FIG. 5 but the base 20 still remains in a horizontal position.

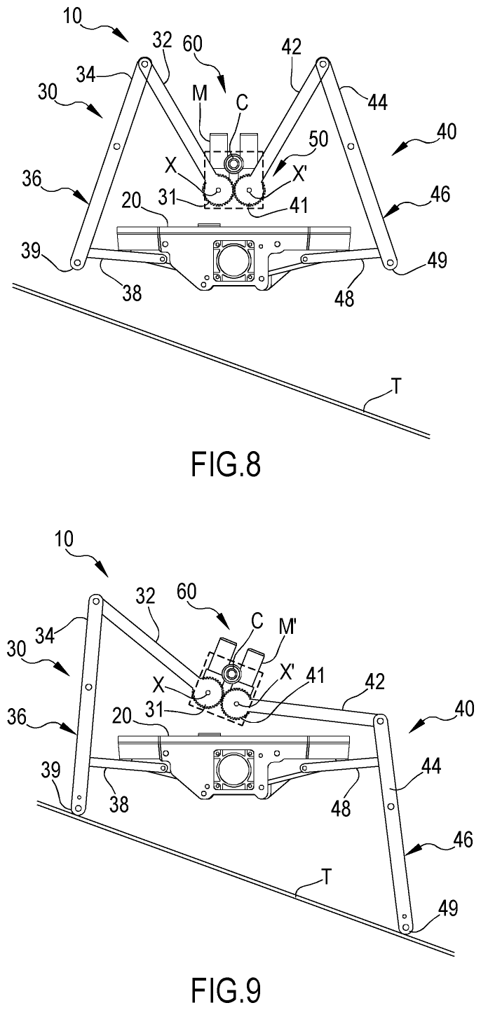

FIGS. 8 and 9 depicts movements similar to those shown in FIGS. 4 and 5 above, the only difference being that in this case the wheelchair 100 is on a slope having a 20° gradient.

In this case, in the final position shown in FIG. 9, the shared gear 50 is more tilted than in the position shown in FIG. 7 but the base 20 still remains in a horizontal position.

The parking device 10 further provides a locking system that suppresses the degree of freedom of the system composed of the leverages 30, 40 and the gearmotor 50 when both feet 39, 49 are on the ground.

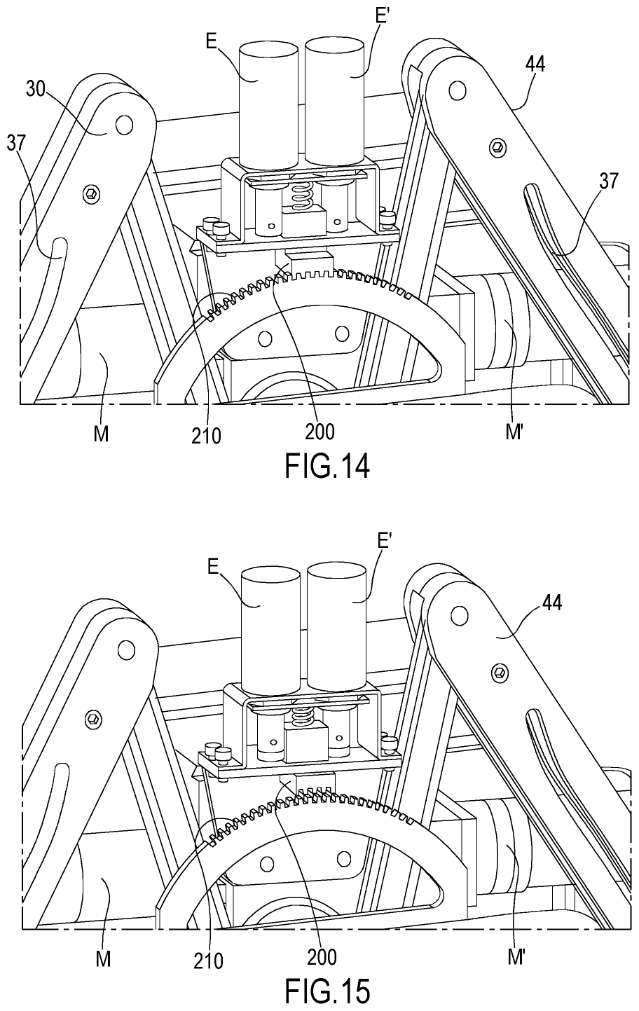

This locking system is shown in FIG. 14 in the locked position and in FIG. 15 in the unlocked position.

In particular, the locking system provides a pair of electromagnets E, E′ that are configured to drive a toothed element 200 from a first position, in which the toothed element 200 is hooked by a crown wheel 210 integral to a supporting frame of the self-balancing wheelchair 100, to a second position, in which said toothed element 200 is unhooked from the aforesaid crown wheel 210.

In this first position, the locking system ensures the stability of the parking device 10 which would otherwise be unstable, since by applying a torque to the base 20, the latter would tend to rotate thus causing the wheelchair 100 to move forward.

In addition, when the pair of electromagnets E, E′ is activated, the crown wheel 210 is unhooked and the locking system is unlocked.

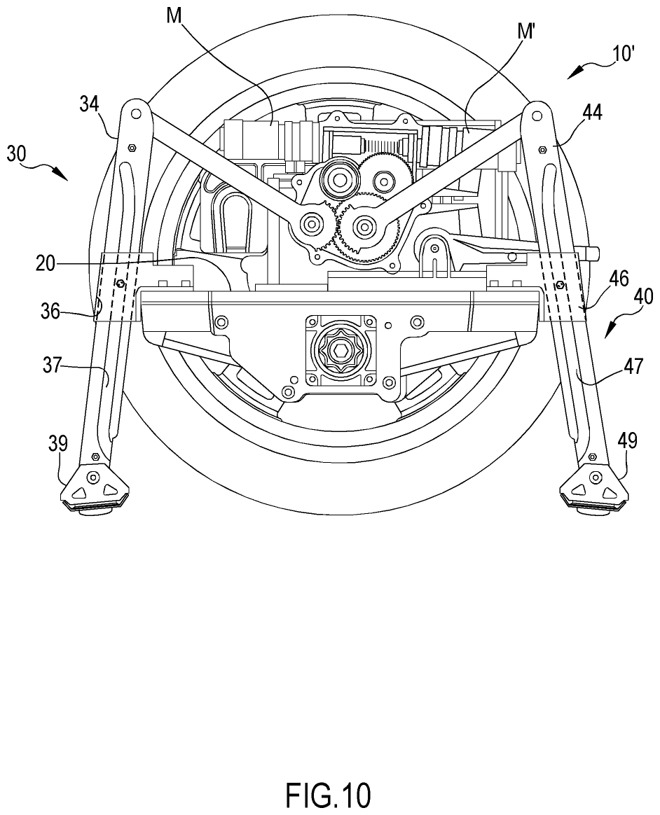

FIG. 10 depicts a side view of a portion of motorized self-balancing wheelchair equipped with a parking device 10′, according to an alternative embodiment of the present invention.

This embodiment differs from the embodiment of FIGS. 1-9 in that it provides a gearmotor assembly 60′ that drives a shared gear 50′, which comprises a worm screw 51 acting on a cogwheel 52, which cogwheel drives an additional cogwheel 54 meshed with the rear cogwheel 41 of the shared gear 50′.

Also in this case, the gearmotor assembly 60′ comprises a pair of motors M, M′ which both act on the aforesaid worm screw 51.

The rotation of the rear cogwheel 41 of the shared gear 50′ is then transmitted to the front cogwheel 31 of the shared gear 50′ in a manner similar to those seen above.

Alternatively, the kinematic mechanism described above can be reconfigured so that the cogwheel 54 is meshed with the front cogwheel 31 of the shared gear 50′.

In particular, the operation of the gearmotor assembly 60 activates the worm screw 51 and, according to the kinematic mechanisms described above, simultaneously rotates the pair of cogwheels 31, 41 so as to cause both the proximal lever 32 of the front leverage 30 to rotate around its rotation axis X and the proximal lever 42 of the rear leverage 40 to rotate around its rotation axis X′.

The proximal lever 32 acts on the distal lever 34, which is guided by the guide 36 downward until touching the ground, as well as, in the same way, the proximal lever 42 acts on the distal lever 44, which is guided downward by the guide 46.

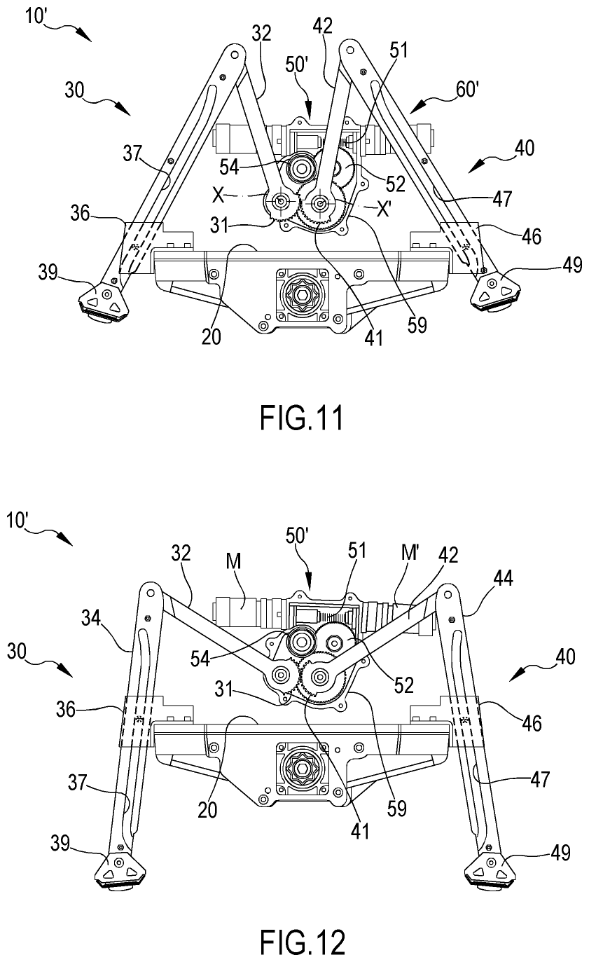

Specifically, the distal lever 34 is guided by the guide 36 thanks to a cam 37 present on the distal lever 34 itself, while the distal lever 44 is guided by the guide 46 thanks to a cam 47 present on the distal lever 44 itself, so that the parking device switches from the retracted position in FIG. 11 to the extended position in FIG. 12.

The operation of the gearmotor assembly 60′ in the opposite direction allows the device to repeat in reverse the same movements described in order to lead the parking device 10′ from an extended position (FIG. 12) to a retracted position (FIG. 11).

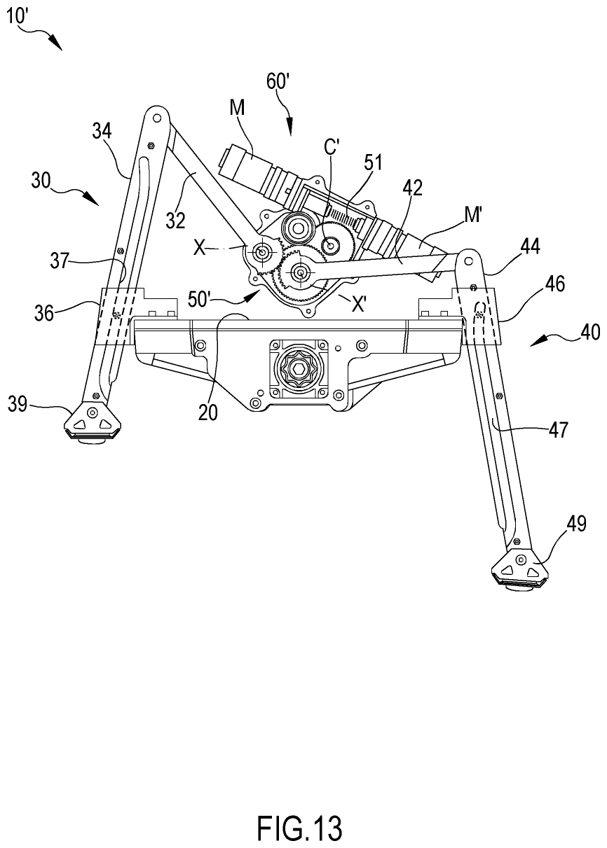

If the wheelchair 100 is on sloping ground, at the moment in which the distal lever 34 and the respective foot 39 touch the ground T, the shared gear 50′ rotates about its center of rotation C′ and allows the distal lever 44 and the respective foot 49 to reach the contact with the ground T, thus leading the parking device 10′ to the position shown in FIG. 13.

The foot 39 can be articulated with respect to the distal lever 34, just as the foot 49 can be articulated with respect to the distal lever 44, so as to provide better ground support to the parking device 10′.

In both the described embodiments, the gearmotor assembly 60, 60′ can be driven electrically, for example by an appropriate control available to the user of the wheelchair 100.

Modifications or improvements suggested by incidental or particular reasons can be made to the invention as previously described, without thereby departing from the scope of the invention.

For example, two electric motors that are electronically synchronized can be mounted in place of the pair of motors acting on the worm screw, in order to simultaneously rotate the proximal levers 32, 42 with respect to the X, X′ axes and achieve the same result in terms of kinematic mechanism.

1. A parking device for a motorized self-balancing wheelchair (100), wherein the device is connected to a base of the self-balancing wheelchair by means of a pair of leverages, wherein each of the leverages is connected, by means of a proximal lever, to a shared gear that can be driven by means of a gearmotor assembly (60, 60′) that in turn is constrained, to one of the leverages, each of the proximal levers being articulated to a respective distal lever, wherein each of the distal levers is guided along a respective guide, wherein the guide is constrained to the base of the wheelchair and has a respective supporting foot for supporting on the ground, wherein the shared gear has a pair of cogwheels meshing with one another, wherein each of the cogwheels is integral to a respective proximal lever of the leverages and has its own rotation axis, in such a way that the operation of the gearmotor assembly puts the pair of cogwheels in simultaneous rotation to drive the leverages up or down.

2. The parking device according to claim 1, wherein the shared gear comprises a worm screw acting on a cogwheel, which cogwheel drives a further cogwheel meshed with one of the cogwheels of the shared gear.

3. The parking device according to claim 1, wherein the shared gear is accommodated in a holder having a fulcrum at a rotation that is different from the rotation axes of the cogwheels.

4. The parking device according to claim 2, wherein the gearmotor assembly comprises a pair of motors which both act on the worm screw.

5. The parking device according to claim 1, wherein each of the distal levers is connected, by means of a respective guide, to a respective connecting lever that in turn is fixed to the base.

6. The parking device according to claim 1, wherein the device further provides a locking system which suppresses the degree of freedom of the system composed of the leverages and the gearmotor when both feet are on the ground, in order to ensure the stability of the parking device.

7. The parking device according to claim 6, wherein the locking system provides a pair of electromagnets that are configured to drive a toothed element from a first position, in which said toothed element is hooked to a crown wheel integral to a supporting frame of the self-balancing wheelchair, to a second position, in which said toothed element is unhooked from the crown wheel.

8. The parking device according to claim 1, wherein the supporting feet to be supported on the ground are articulated with respect to the corresponding distal levers.

9. The parking device according to claim 1, wherein the distal levers are guided by the respective guides by means of cams present on the distal levers themselves to make the parking switch from a retracted position to an extended position and vice-versa.

10. The parking device according to claim 1, wherein the gearmotor assembly can be driven electrically.
